(19) United States
(12) Patent Application Publication
(10) Pub. No.: US 2006/0190577 A1
(43) Pub. Date: Aug. 24, 2006

(54) Content output device

(75) Inventor: Tomohiro Yamada, Itami-shi (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: SANYO ELECTRIC CO., LTD., Moriguchi-shi (JP)

(21) Appl. No.: 10/564,636

(22) PCT Filed: Jul. 20, 2004
(86) PCT No.: PCT/JP04/10595

§ 371 Date: Jan. 13, 2006

(30) Foreign Application Priority Data
Jul. 23, 2003 (JP) 2003-277962

(51) Int. Cl. G06F 15/173

(52) U.S. Cl. 709/223

(57) ABSTRACT

An Internet radio device (10), when an N-th radio station server (200) is selected, receives streaming contents from five N−2-th to N+2-th radio station servers (200, 200, . . . ), writes them respectively into five buffers, and reads only the streaming content from the N-th radio station server (200) via the buffer and reproduces it. After that, when a station change operation is performed for a change to a neighboring station, that is, the N−1-th or N+1-th radio station server (200), the Internet radio device (10) reads only the streaming content from the N−1-th or N+1-th radio station server (200) via the buffer and reproduces it.

### TECHNICAL FIELD

The present invention relates to a content output apparatus. More specifically, the present invention relates to a content output apparatus that outputs any one of N streaming contents (N: 2 or any larger integer) transmitted through N channels, respectively.

### PRIOR ART

One example of this kind of conventional content output apparatus is disclosed in Japanese Patent Laying-open No. 2002-82959 laid-open on Mar. 22, 2002. This prior art makes it possible to fetch streaming data of a radio broadcast transmitted via the Internet into a buffer memory, and output sounds based on the fetched streaming data through a speaker. With the prior art, however, the streaming data is temporarily stored in the buffer memory, which causes a problem of requiring time between the selection of a desired channel and the output of the sounds.

### SUMMARY OF THE INVENTION

Therefore, it is a primary object of the present invention to provide a novel content output apparatus.

It is another object of the present invention to provide a content output apparatus that allows the enhancement of response characteristic.

A content output apparatus according to the present invention of claim 1 is a content output apparatus that outputs any one of N contents (N: 2 or any larger integer) individually transmitted through N channels registered in a predetermined order, and comprises a writing means for respectively writing M contents (M: an arbitrary integer that is 2 or larger and N or smaller) transmitted through M channels that exist in a predetermined order and include a desired channel into M buffer memories, a reading means for reading a content transmitted through the desired channel from any one of the M buffer memories, and an accepting means for accepting changes of the desired channel in the predetermined order.

In the present invention of claim 1, the writing means writes individually the M contents transmitted through the M channels that exist in the predetermined order and include a desired channel, into the M buffer memories. The reading means reads the content transmitted through the desired channel from any one of the M buffer memories. Also, the accepting means accepts the changes of the desired channel, that is, the changes of the buffer memories from which the streaming content is to be read in the predetermined order. According to the present invention of claim 1, the reception of the streaming content transmitted through the desired channel is not started after the change of the channel. The streaming content from the changed desired channel is already accumulated in the buffer memories, and thus it is possible to reproduce the streaming content from the desired channel simultaneously with the channel change, which provides a favorable response characteristic.

A content output apparatus according to the present invention of claim 2 depends on claim 1, and the writing means includes an updating means for updating any one of the M buffer memory areas in response to the change of the desired channel.

In the present invention of claim 2, the updating means updates any one of the M buffer memories in response to the change of the desired channel. According to the present invention of claim 2, therefore, the buffer memories are kept in a state of being prepared for the next change of the desired channel.

A content output apparatus according to claim 3 depends on claim 1, and further comprises a holding means for holding a table in which the N channels are registered in the predetermined order and a specifying means for specifying the M channels by reference to the table held by the holding means.

In the present invention of claim 3, the holding means holds the table in which the N channels are registered in the predetermined order, and the specifying means specifies the M channels by reference to the table held by the holding means. Therefore, according to the present invention of claim 3, the table obtained from the tuning server managing the table is held by the holding means, which eliminates the need for referring to the table in the tuning server every time the M channels are specified.

A content output apparatus according to the present invention of claim 4 depends on claim 1, and the contents are steaming contents transmitted in real time.

In the present invention of claim 4, since the contents are steaming contents transmitted in real time, the present invention is applicable to apparatuses that receive the contents delivered as broadcast data by the Internet radio.

A content output control program according to the present invention of claim 5 is a content output program to be executed by a content output apparatus that outputs any one of N contents (N: 2 or any larger integer) individually transmitted through N channels registered in a predetermined order, and comprises a writing step of respectively writing M contents (M: an arbitrary integer that is 2 or larger and N or smaller) transmitted through M channels that exist in a predetermined order and include a desired channel into M buffer memories, a reading step of reading a content transmitted through the desired channel from any one of the M buffer memories, and an accepting step of accepting changes of the desired channel in a predetermined order.

In the present invention of claim 5, firstly, the M contents transmitted through the M channels that exist in the predetermined order and include the desired channel are respectively written into M buffer memories. Next, the content transmitted through the desired channel is read from any one of the M buffer memories. Then, the changes of the desired channel are accepted in the predetermined order. Therefore, according to the present invention of claim 5, the reception of the streaming content transmitted through the desired channel is not started after the change of the channel. The streaming content from the changed desired channel is already accumulated in the buffer memories, and thus it is possible to reproduce the streaming content from the desired channel simultaneously with the channel change, which provides a favorable response characteristic.

A content output control method according to the present invention of claim 6 is a content output control method that is to be practiced by a content output apparatus that outputs any one of N contents (N: 2 or any larger integer) individually transmitted through N channels registered in a predetermined order, and comprises a writing step of respectively writing M contents (M: an arbitrary integer that is 2 or larger and N or smaller) transmitted through M channels that exist in a predetermined order and include a desired channel into M buffer memories, a reading step of reading a content transmitted through the desired channel from any one of the M buffer memories, and an accepting step of accepting changes of the desired channel in the predetermined order.

A content output control method according to the present invention of claim 7 depends on claim 6, and the reading step includes a changing step of, when the change of the desired channel is accepted in the accepting step, changing a buffer memory from which the content is to be read.

According to the present invention of claim 7, since the buffer memory from which the content is to be read is changed immediately after the change of the desired channel, it is possible to reproduce the streaming content from the desired channel instantaneously with the channel change.

A content output control method according to the present invention of claim 8 depends on claim 6, and the writing step includes an replacing step of, when the change of the desired channel is accepted in the accepting step, replacing any one of the M channels with any one of channels that are included in the N channels and are not included in the M channels.

According to the present invention of claim 8, since any one of the M channels is replaced with another one at each channel change, the M contents transmitted through the M channels including the desired channel are accumulated at any time in the M buffers. As a result, it is possible for the M buffers to be prepared for the next change of the desired channel.

According to the present invention, the steaming contents from several channels preceding and following the desired channel are received and accumulated in the buffers, and when the desired channel is changed to any one of the channels preceding or following the desired channel, the streaming content accumulated in advance in the buffers is reproduced. Therefore, the response characteristic at the time of channel change is enhanced.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an illustrative view showing one applied example of the present invention;

FIG. 2 is a block diagram showing schematic structure of a content output apparatus;

FIG. 3 is a block diagram showing schematic structure of a radio station server; FIG. 4 is a block diagram showing schematic structure of a tuning server;

FIG. 5 is an example of configuration of a radio station database held by the tuning server;

FIG. 6(A) to FIG. 6(E) are illustrative views sequentially showing examples of operations of buffers in the content output apparatus;

FIG. 7(A) to FIG. 7(E) are illustrative views sequentially showing examples of operations of the buffers in the content output apparatus;

FIG. 8 is a flowchart showing an operation of an MCU of the content output apparatus;

FIG. 9 is a flowchart showing an operation of the MCU of the content output apparatus;

FIG. 10 is a flowchart showing an operation of a CPU of the tuning server;

FIG. 11 is a flowchart showing an operation of the CPU of the tuning server; and

FIG. 12 is a flowchart showing an operation of a CPU of the radio station server.

### BEST MODE FOR PRACTICING THE INVENTION

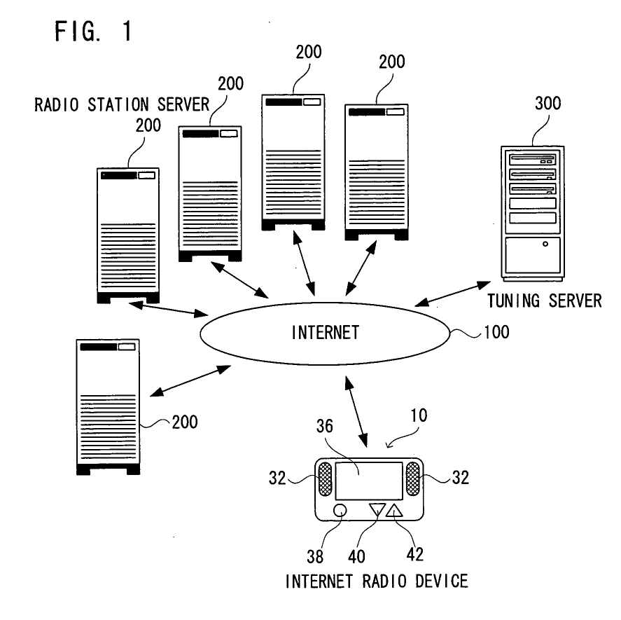

An Internet radio device 10, as a content output apparatus of one embodiment of the present invention shown in FIG. 1, is connected to the Internet 100. In addition to the Internet radio device 10, connected to the Internet 100 are a plurality of radio station servers 200 for offering stream distribution of contents to the Internet radio device 10 and a tuning server 300 for providing information on the radio station server 200 to the Internet radio device 10.

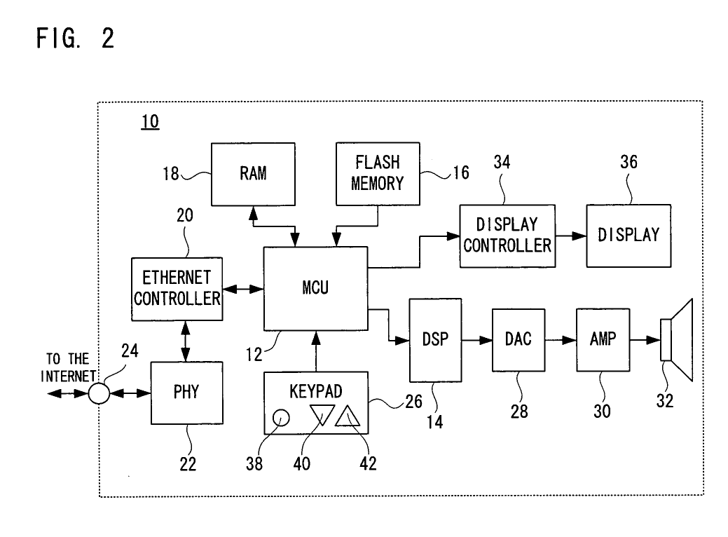

The Internet radio device 10, more specifically, is structured as shown in FIG. 2. As illustrated in FIG. 2, an MCU (Micro Controller Unit) 12 is connected with a DSP (Digital Signal Processor) 14, a flash memory 16, a RAM 18, an Ethernet controller (Ethernet: registered trademark) 20, a key pad 26 and a display controller 34.

The flash memory 16 stores programs to be executed by the MCU 12. At execution of the programs, the MCU 12 uses the RAM 18 as a working area.

Provided on the key pad 26 are a power button 38, a down button 40 and an up button 42. The power button 38 is a button for turning on or off an electric power of the Internet radio device 10. The down button 40 is a button for selecting a radio station in descending order (described later in detail), and the up button 42 is a button for selecting a radio station in ascending order (described later in detail).

The display controller 34 is connected with a display 36. The MCU 12 controls the display controller 34, thereby displaying predetermined information on the display 36.

The DSP 14 is connected with a speaker 32 via a D/A converter 28 and an AMP 30. A digital audio signal provided by the MCU 12 to the DSP 14 is decoded and converted into an analog audio signal by the D/A converter 28, and then provided to the AMP 30. The AMP 30 amplifies the provided analog audio signal and outputs it to the speaker 32. This allows sounds to be output from the speaker 32.

The Ethernet controller 20 is connected via a PHY 22 to a communication connector 24 leading to the Internet 100. This permits the MCU 12 to receive data from the Internet 100 and transmit data to the Internet 100. Besides, the PHY 22 is a network adapter for connecting electrically and mechanically a network controller chip set (the Ethernet controller 20) with a network cable connector (the communication connector 24).

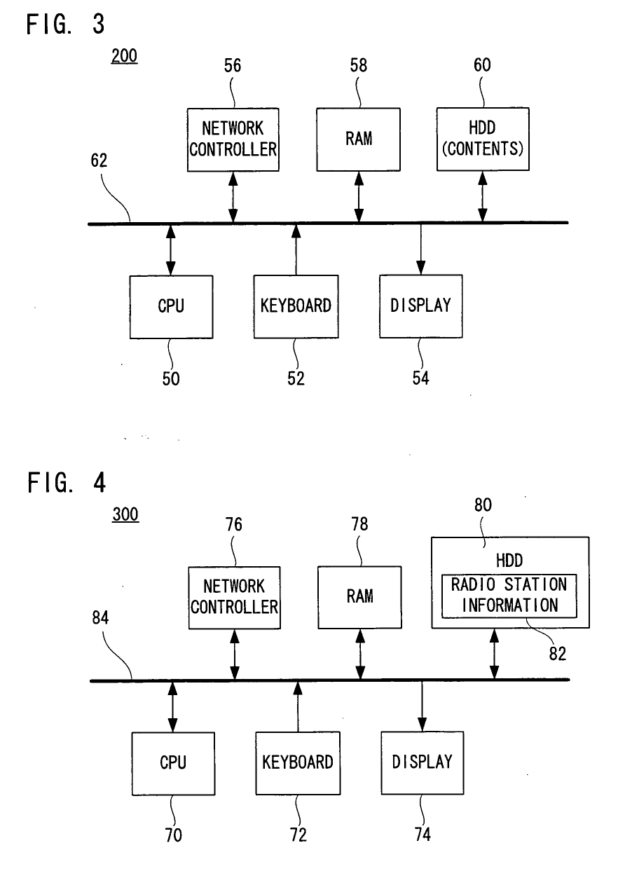

In addition, the radio station server 200, more specifically, is structured as shown in FIG. 3. As illustrated in FIG. 3, a CPU 50 is connected via a bus 62 with a keyboard 52, a display 54, a network controller 56, a RAM 58 and an HDD (Hard Disc Drive) 60. Moreover, the HDD 60 records contents for stream distribution (audio data for radio programs) to the Internet radio device 10.

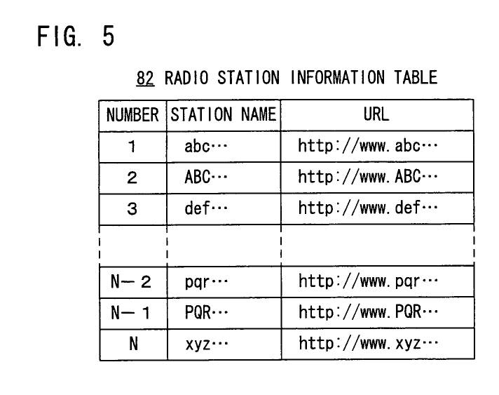

Furthermore, the tuning server 300, more specifically, is structured as shown in FIG. 4. As illustrated in FIG. 4, a CPU 70 is connected via a bus 84 with a keyboard 72, a display 74, a network controller 76, a RAM 78 and an HDD80. Moreover, the HDD 80 records a radio station information table 82 that lists information on the radio station servers 200 connected to the Internet 100. As shown in FIG. 5, the radio station information table 82 records three items of “radio station number”, “station name” and “URL” for each of the radio station server 200. The radio station number here denotes a serial number allocated by the tuning server 300 to each of the radio station servers 200 existing on the Internet 100. Although the ordering of the radio station numbers has no special meaning, the selection of radio stations on the Internet radio device 10 is made in order of the radio station numbers (descending order or ascending order).

The conventional Internet radio device (such as a personal computer), in selecting a radio station (radio station server 200), starts reception of streaming data distributed by the radio station server 200 of the radio station after the user's designation of the radio station, and then reproduces a predetermined amount of received streaming data after accumulation of the streaming data in the buffer. Thus, it takes time between the user's designation of the radio station and the output of sounds from the radio station through a speaker. This results in impairment of response characteristic.

The Internet radio device 10 to which the present invention applies, when the user operates the power button 38 to power on the internet radio device 10 is firstly connected to the tuning server 300 via the Internet 100. When the Internet radio device 10 is connected to the tuning server 300, the tuning server 300 transmits the radio station information table 82 shown in FIG. 5 to the Internet radio device 10. Here, as illustrated in FIG. 5, there exist N radio station servers 200 on the Internet 100.

Upon reception of the radio station information table 82, the Internet radio device 10 refers to the radio station information table 82 and connects simultaneously to five radio station servers 200 including a first radio station server 200 as a middle of them, that is, N−1th, N-th, first, second and third radio station servers 200. Then, the Internet radio device 10 receives stream distribution (radio broadcasts) through the five channels (the radio station servers 200).

The streaming data distributed from the five radio station servers 200 are accumulated in five buffers provided in the RAM 18 of the Internet radio device 10, respectively. Out of the accumulated streaming data, only the streaming data from the first radio station server 200 is reproduced.

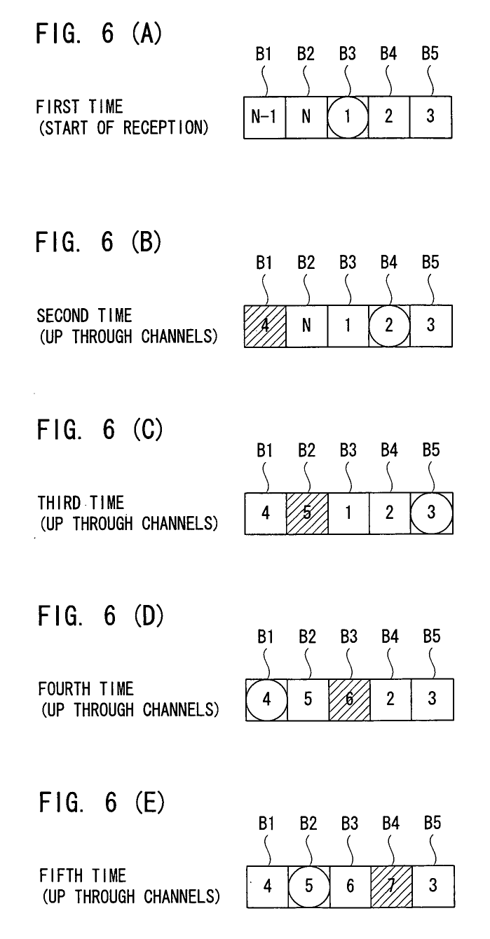

At that time, as shown in FIG. 6(A), the streaming data from the first radio station server 200 is accumulated in the third buffer B3, the streaming data from the second radio station server 200 is accumulated in the fourth buffer B4, the streaming data from the third radio station server 200 is accumulated in the fifth buffer B5, the streaming data from the N-th radio station server 200 is accumulated in the second buffer B2, and the streaming data from the N−1-th radio station server 200 is accumulated in the first buffer B1. That is, it is assumed that the first radio station server 200 is selected, and the streaming data from the two each radio station servers 200 preceding and following the first one are accumulated in the individual buffers. Then, out of the streaming data accumulated in the individual buffers, only the streaming data from the first radio station server 200 (the streaming data accumulated in the buffer B3 marked with a circle) is reproduced.

Here, for selection of a desired channel, when the user operates the up button 42 to select the second radio station server 200, the streaming data accumulated in the fourth buffer B4 is reproduced, instead of the streaming data accumulated in the third buffer B3, as shown in FIG. 6(B).

The streaming data from the second radio station server 200 is accumulated in the buffer prior to the channel change by the user, which makes it possible to listen to the broadcast from the second radio station server 200 simultaneously with the channel change. Thus, when changing the channel, the user can listen to the broadcast from the next radio station server 200 without having a wait time and determine quickly whether this is the broadcast he/she wishes to listen to or not.

When the reproduction of streaming data is changed from the third buffer B3 to the fourth buffer B4, as indicated with oblique lines in FIG. 6(B), the streaming data to be accumulated in the first buffer B1 is changed from the streaming data from the N−1-th radio station server 200 to the streaming data from the fourth radio station server 200. This is for the purpose of allowing the streaming data from the two each radio station servers 200 preceding and following the selected radio station server 200 to be accumulated at any time.

FIG. 6(C), FIG. 6(D) and FIG. 6(E) show the state of changes in the streaming data to be accumulated in the individual buffers when the user further operates the up button 42 to move up through the channels. In addition, the streaming data accumulated in the buffer marked with a circle is reproduced, and the streaming data to be accumulated in the buffer indicated with oblique lines is changed.

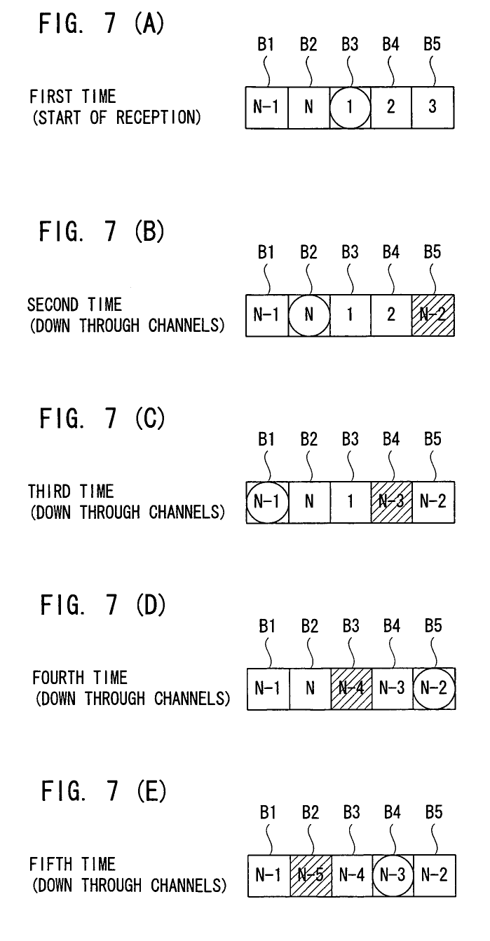

When the user operates the down button 40 to move down through the channels, the streaming data to be reproduced is changed from the streaming data accumulated in the third buffer B3 to the streaming data from the N-th radio station server 200, which is accumulated in the second buffer B2, as shown in FIG. 7(A) and FIG. 7(B). Then, in order to accumulate the streaming data from the radio station servers 200 of two each numbers preceding and following the N-th one, the streaming data to be accumulated in the fifth buffer B5 is changed from the streaming data from the third radio station server 200 to the streaming data from the N−2-th radio station server 200.

FIG. 7(C), FIG. 7(D) and FIG. 7(E) show the state of changes in the streaming data to be accumulated in the individual buffers when the user further operates to move down through the channels.

Description is given below as to the operations of the MCU 12 of the Internet radio device 10, the CPU 50 of the radio station server 200, and the CPU 70 of the tuning sever 300.

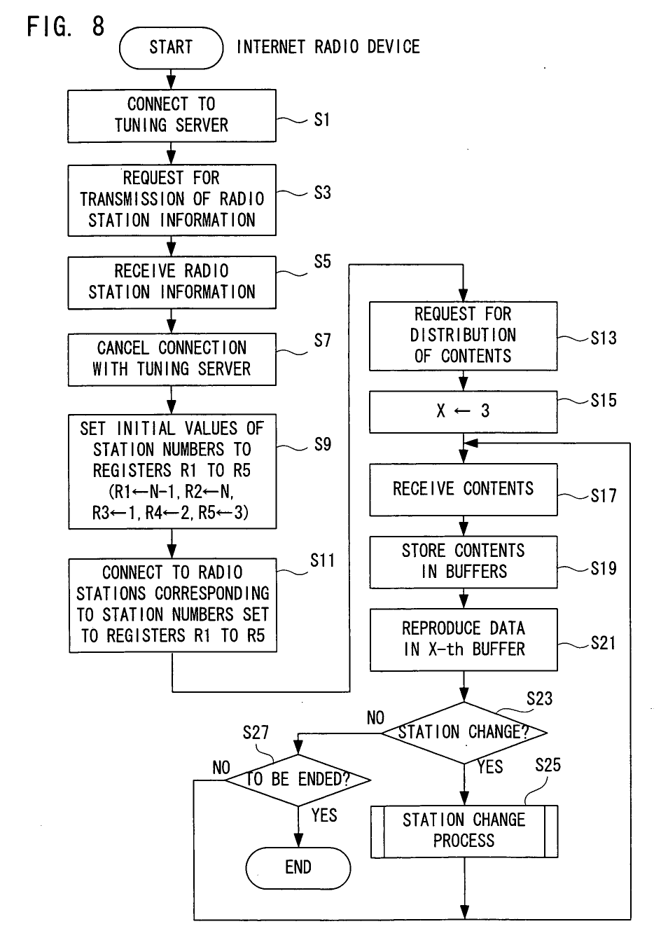

When the user of the Internet radio device 10 operates the power button 38 provided in the key pad 26 to power on the Internet radio device 10, the MCU 12 of the Internet radio device 10 connects the same to the tuning server 300 based on a URL recorded in advance in the flash memory 16 in a step S1 of FIG. 8. Then, in a step S3, a request for transmission of the radio station information table 82 is made to the tuning server 300.

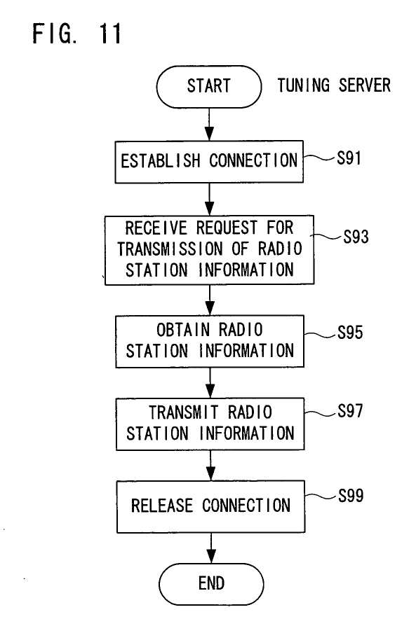

In the tuning server 300, the CPU 70 establishes connection with the Internet radio device 10 in a step S91 of FIG. 11 and receives the request for transmission of the radio station information from the Internet radio device 10 in a step S93. The radio station information table 82 is obtained from the HDD 80 in a step S95, and the obtained radio station information table 82 is transmitted to the Internet radio device 10 in a step S97. Then, the connection with the Internet radio device 10 is canceled in a step S99.

In the Internet radio device 10, the radio station information table 82 transmitted from the tuning server 300 is received in a step S5 of FIG. 8. Then, the connection with the tuning server 300 is canceled in a step S7.

In a step S9, initial values for the radio station numbers are set to registers R1, R2, R3, R4 and R5. More specifically, “N−1” is set to the register R1, “N” is set to the register R2, “1” is set to the register R3, “2” is set to the register R4, and “3” is set to the register R5. The registers R1, R2, R3, R4 and R5 correspond to the buffers B1, B2, B3, B4 and B5, respectively. For example, if the value set to the register R1 (the station number) is “N−1”, the streaming data from the radio station server 200 with the radio station number “N−1” is accumulated in the buffer B1.

In a step S11, connections are made to the radio station servers 200 corresponding to the respective station numbers set to the registers R1, R2, R3, R4 and R5. That is, connects are simultaneously made to the five radio station servers 200. Then, in a step S13, a request for distribution of contents is transmitted to each of the five radio station servers 200 connected in the step S11.

In a step S15, “3” is stored in a variable X. X is a variable for specifying the buffer in which the streaming data to be reproduced is accumulated, and indicates any one of values “1” to “5”. The values “1” to “5” correspond to the buffer B1, B2, B3, B4 and B5, respectively. Since X=3 at this time, the third buffer B3 is specified.

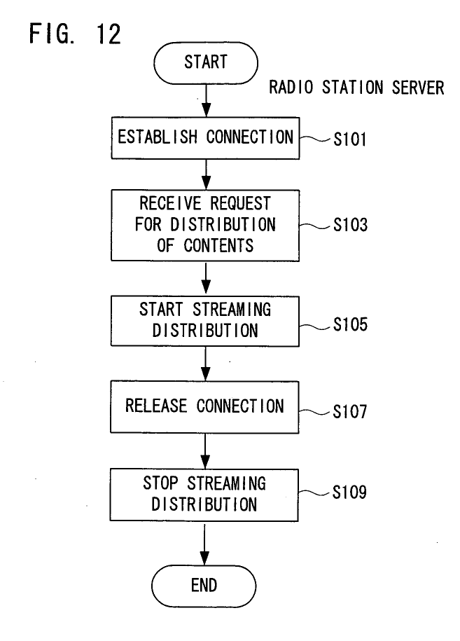

In the radio station server 200, the CPU 50 establishes connection with the Internet radio device 10 in a step S101 of FIG. 12, and receives a request for distribution of a content from the Internet radio device 10 in a step S103. Upon reception of the content distribution request, the stream distribution of the content (radio broadcast) is started in a step S105. The streaming distribution is continued until the Internet radio device 10 releases the connection. Upon release of the connection in a step S107, the stream distribution is stopped in a step S109.

When the radio station server 200 has started the stream distribution, the Internet radio server 10 receives contents (streaming data) distributed from the five radio station servers 200 in the step S17 and stores the five kinds of received streaming data in the respective buffers. The streaming data from the N−1-th radio station server 200 is stored in the buffer B1, and the streaming data from the N-th radio station server 200 is stored in the buffer B2, the streaming data from the first radio station server 200 is stored in the buffer B3, the streaming data from the second radio station server 200 is stored in the buffer B4, and the streaming data from the third radio station server 200 is stored in the buffer B5. In a step S21, the streaming data stored in the X-th (the third one at this time) buffer is reproduced.

When the user operates the down button 40 or the up button 42 provided in the key pad 26, it is determined in a step S23 that a station change operation has been performed, and a station change process is executed in a step S25. In the station change process, the value of the variable X according to the selected radio station is changed and the buffer in which the streaming data is to be reproduced is changed. Additionally, although the details are provided later, in the station change process, the radio station server 200 as a transmission source of the streaming data stored in one buffer is changed with the change of the buffer in which the streaming data is to be reproduced.

Then, the contents (streaming data) are received again from the five radio station servers 200 in the step S17, and the five received contents (streaming data) are stored in the five respective buffers in a step S19. In the step S21, the streaming data accumulated in the X-th buffer (the second or fourth one at this time because the previous is the third one) is reproduced.

When the user operates the power button 38 provided in the key pad 26, it is determined in a step S27 that an end operation has been performed, and an end process is executed to turn the power off.

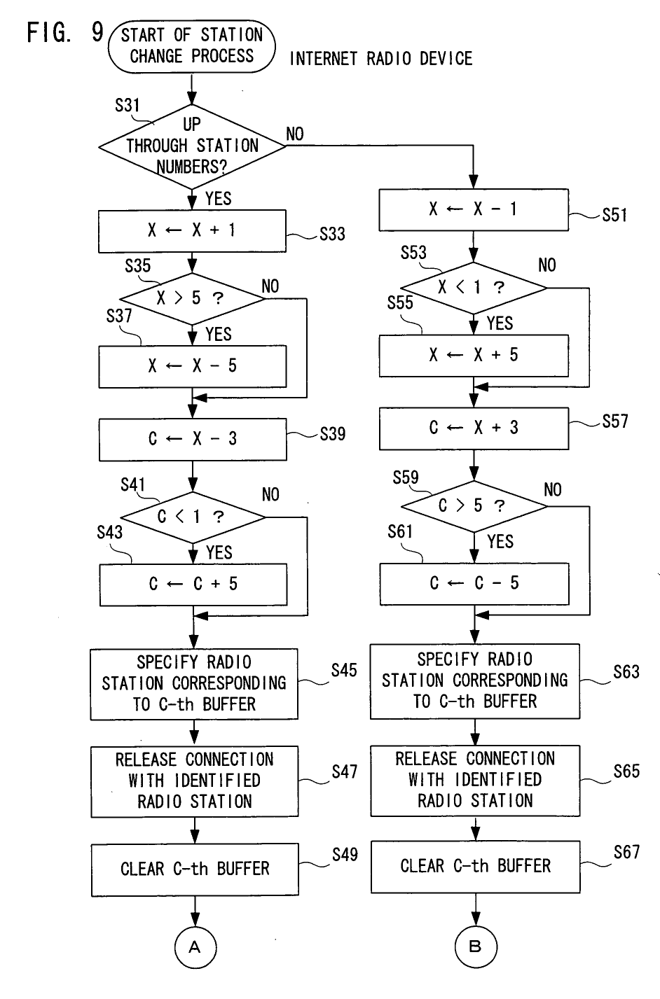

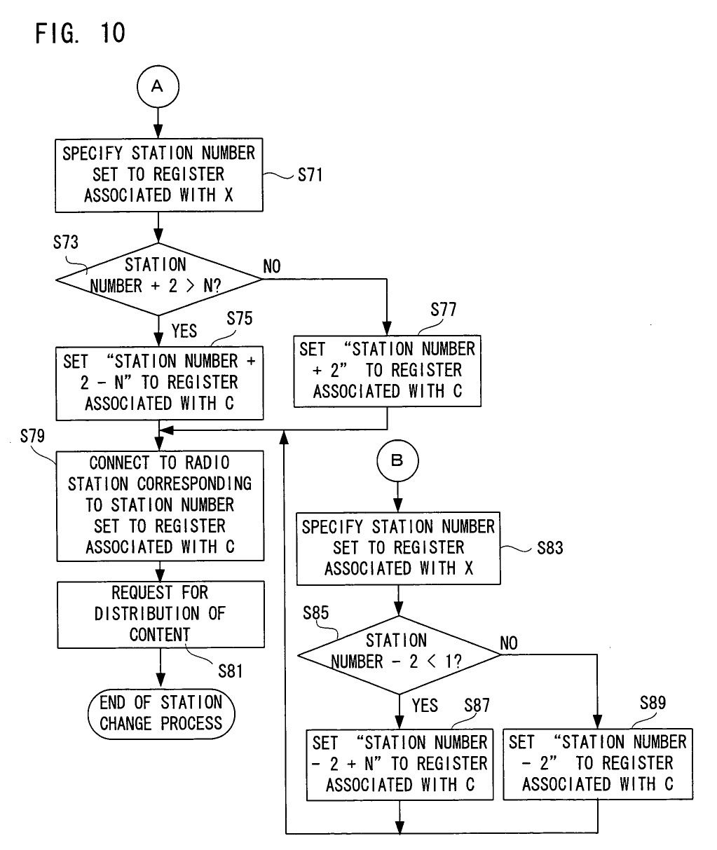

The station change process is executed according to the procedure shown in the flowchart of FIG. 9 and FIG. 10. Firstly, it is determined in a step S31 whether or not the user has designated moving up through the channels (the station numbers) by operating the key pad 26 (operating the up button 42).

If it is concluded in the step S31 that the moving up through the station numbers has been designated, the value assigned to the variable X is incremented by “1” in a step S33. Then, it is determined in a step S35 whether the value of the variable X is larger than “5” or not. If the value of the variable X is larger than “5”, “5” is subtracted from the value of the variable X in a step S37. The process of step S37 corresponds to a case where the buffer in which the accumulated streaming data is to be reproduced is changed from the fifth buffer B5 to the first buffer B1, as shown in FIG. 6(C) and FIG. 6(D). Thus, with a continuous upward move through the station numbers, the buffer in which the streaming data is to be displayed is changed in a cyclical manner.

In a step S39, “X−3” is assigned to a variable C. The variable C is a variable for specifying the buffer in which the accumulated streaming data is to be updated, and indicates any one of values “1” to “5”. The values “1” to “5” correspond to the buffers B1, B2, B3, B4 and B5, respectively. In the example of FIG. 6(B), the first buffer B1 is a buffer to be updated and the value of the variable C is “1” at this time.

In a step S41, it is determined whether the value of the variable C is smaller than “1” or not. If the value of the variable C is smaller than “1”, “5” is added to the value of the variable C in a step S43. The process of step S43 is a preparation for the case where the buffer in which the streaming data is to be reproduced is the first one (the value of the variable X is “1”) and the value resulting from a subtraction of “3” from the value of the variable X (that is, the value assigned to the variable C) is smaller than “1”, as shown in FIG. 6(D) and FIG. 6(E).

In a step S45, the radio station server 200 corresponding to the C-th buffer, that is, the radio station server 200 that distributes streaming data accumulated in the C-th buffer is specified. Then, in a step S47, the connection with the identified radio station server 200 is released. Moreover, in a step S49, the C-th buffer is cleared to erase the streaming data accumulated therein.

In a step S71 of FIG. 10, the station number set to the register corresponding to the variable X (the X-th register) is specified. Then, in a step S73, it is determined whether the “specified station number+2” is larger than “N” or not. If the “station number+2” is larger than “N”, the “station number+2−N” is set to the register corresponding to the variable C (the C-th register) in a step S75. On the other hand, if the “station number+2” is “N” or smaller, the “station number+2” is set to the register corresponding to the variable C (the C-th register) in a step S77. With this, it is decided the radio station server 200 of what number (the station number set to the C-th register) is to be the transmission source of streaming data to be accumulated in the C-th buffer.

Then, in a step S79, connection is made to the radio station server 200 associated with the station number set to the register corresponding to the variable C (the C-th register). In a step S81, a request for distribution of a content is transmitted to the radio station server 200 associated with the station number set to the register corresponding to the variable C, and the station change process is ended. Besides, the content (stream data) from the radio station server 200 associated with the station number set to the register corresponding to the variable C is received together with the contents (streaming data) from the other four radio station servers 200 in the step S17 of FIG. 8, after the end of the station change process.

If it is concluded in the step S31 that the upward move through the station numbers has not been designated (the downward move through the station number has been designated), the value assigned to the variable X is decremented by “1” in a step S51. Then, it is determined in a step S53 whether the value of the variable X is smaller than “1” or not. If the value of the variable X is smaller than “1”, “5” is added to the value of the variable X in a step S55. The process of step S55 conforms to a case where the buffer in which the accumulated streaming data is to be reproduced is changed from the first buffer B1 to the fifth buffer B5. Thus, with a continuous downward move through the station numbers, the buffer in which the streaming data is to be reproduced is changed in a cyclical manner.

In a step S57, “X+3” is assigned to the variable C. The variable C is a variable for specifying the buffer in which the accumulated streaming data is to be updated, and indicates any one of values “1” to “5”. The values “1” to “5” correspond to the buffers B1, B2, B3, B4 and B5, respectively. In the example of FIG. 7(B), the fifth buffer B5 is a buffer to be updated, and the value of the variable C is “5” at this time.

In a step S59, it is determined whether the value of the variable C is larger than “5” or not. If the value of the variable C is larger than “5”, “5” is subtracted from the value of the variable C in a step S61. The process of step S61 is a preparation for the case where the buffer in which the streaming data is to be reproduced is the fifth one (the value of the variable X is “5”) and the value resulting from an addition of 3 to the value of the variable X (i.e. the value assigned to the variable C) is larger than 5, as shown in FIG. 7(D) and FIG. 7(E).

In a step S63, the radio station server 200 corresponding to the C-th buffer, that is, the radio station server 200 that distributes the streaming data accumulated in the C-th buffer is specified. Then, in a step S65, the connection with the specified radio station server 200 is released. Moreover, in a step S67, the C-th buffer is cleared to erase the streaming data accumulated therein.

In a step S83 of FIG. 10, the station number set to the register corresponding to the variable X (the X-th register) is specified. Then, in a step S85, it is determined whether the “specified station number−2” is smaller than “1” or not. If the “station number−2” is smaller than “1”, the “station number−2+N” is set to the register corresponding to the variable C (the C-th register) in a step S87. On the other hand, the “station number−2” is “1” or larger, the “station number−2” is set to the register corresponding to the variable C (the C-th register) in a step S89. With this, it is decided the radio station server 200 of what number (the station number set to the C-th register) is to be the transmission source of the streaming data to be accumulated in the C-th buffer.

Then, in the step S79, connection is made to a radio station server 200 associated with the station number set to the register corresponding to the variable C (the C-th register). In the step S81, a request for distribution of a content is transmitted to the radio station server 200 associated with the station number set to the register corresponding to the variable C, and the station change process is ended. Besides, the content (stream data) from the radio station server 200 associated with the station number set to the register corresponding to the variable C is received together with the contents (streaming data) from the other four radio station servers 200 in the step S17 of FIG. 8, after the end of the station change process.

As described above, according to the Internet radio device 10, when a channel is selected from which a broadcast is to be listened, the streaming data (broadcast data) from the selected channel and the two each channels preceding and following the selected channel are stored in the buffers. Since the streaming data from the two each preceding and following channels are stored in the buffers, even if the channel from which a broadcast is to be listened is changed to a channel preceding or following the currently selected channel, the streaming data from that channel is immediately retrieved from the buffer and reproduced. This provides a favorable response characteristic at the time of channel change and allows the user to listen to a broadcast from the next channel without having any wait time.

The above described embodiment can be implemented in various different manners. For example, in the above stated example, the radio station numbers for the radio station servers 200 are to be allocated by the tuning server 300. Alternatively, the radio station numbers may be allocated by the Internet radio device 10. By doing this, the tuning server 300 can be an existing one.

Moreover, a description is given as to the case of using the five buffers in relation to the above described embodiment. The number of the buffers is not limited to five and M buffers (M: 2 or larger integer) can be used for implementation of the present invention.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A content output apparatus that outputs any one of N contents (N: 2 or any larger integer) individually transmitted through N channels registered in a predetermined order, the content output apparatus comprising:
a writing means for respectively writing M contents (M: an arbitrary integer that is 2 or larger and N or smaller) transmitted through M channels that exist in a predetermined order and include a desired channel into M buffer memories;
a reading means for reading a content transmitted through said desired channel from any one of said M buffer memories; and
an accepting means for accepting changes of said desired channel in said predetermined order.

2. A content output apparatus according to claim 1, wherein said writing means includes an updating means for updating any one of said M buffer memories in response to the change of said desired channel.

3. A content output apparatus according to claim 1, further comprising:
a holding means for holding a table in which said N channels are registered in said predetermined sequence; and
a specifying means for specifying said M channels by reference to said table held by said holding means.

4. A content output apparatus according to claim 1, wherein said contents are steaming contents transmitted in real time.

5. A content output control program to be executed by a content output apparatus that outputs any one of N contents (N: 2 or any larger integer) individually transmitted through N channels registered in a predetermined order, the content output control program comprising:
a writing step of respectively writing M contents (M: an arbitrary integer that is 2 or larger and N or smaller) transmitted through M channels that exist in a predetermined order and include a desired channel into M buffer memories;
a reading step of reading a content transmitted through said desired channel from any one of said M buffer memories; and
an accepting step of accepting changes of said desired channel in said predetermined order.

6. A content output control method to be practiced by a content output apparatus that outputs any one of N contents (N: 2 or any larger integer) individually transmitted through N channels registered in a predetermined sequence, the content output control method comprising:
a writing step of respectively writing M contents (M: an arbitrary integer that is 2 or larger and N or smaller) transmitted through M channels that exist in a predetermined order and include a desired channel into M buffer memories;
a reading step of reading a content transmitted through said desired channel from any one of said M buffer memories; and
an accepting step of accepting changes of said desired channel in said predetermined order.

7. A content output control method according to claim 6, wherein said reading step includes a changing step of, when the change of said desired channel is accepted in said accepting step, changing a buffer memory from which a content is to be read.

8. A content output control method according to claim 6, wherein said writing step includes a replacing step of, when the change of said desired channel is accepted in said accepting step, replacing any one of said M channels with any one of channels that are included in said N channels and are not included in said M channels.
